(19) United States
(12) Patent Application Publication
(10) Pub. No.: US 2024/0175718 A1
(43) Pub. Date: May 30, 2024

(54) SENSING SYSTEM

(71) Applicant: ALPHASENSE LIMITED, Great Notley (GB)

(72) Inventors: Ronan BARON, Great Notley (GB); Michael KELLAWAY, Great Notley (GB); John Andrew JOHNSTON, Great Notley (GB)

(21) Appl. No.: 18/551,559

(22) PCT Filed: Mar. 22, 2022
(86) PCT No.: PCT/GB2022/050721

§ 371 Date: Sep. 20, 2023

(30) Foreign Application Priority Data
Mar. 22, 2021 (GB) 2103980.5

(51) Int. Cl. G01D 3/02; G01D 11/24; G01D 18/00

(52) U.S. Cl. CPC G01D 3/022; G01D 11/245; G01D 18/008

(57) ABSTRACT

A sensing system comprising a sensing unit and a sensor drive, wherein the sensing unit comprises a sensing circuit and a memory circuit, the sensing circuit and the memory circuit being electrically isolated from each other within the sensing unit.

### FIELD OF THE INVENTION

The present invention relates to the field of sensing. More particularly, the present invention relates to calibration in the field of sensing using replaceable sensors driven by sensor drivers to which they remain connected in use.

### BACKGROUND TO THE INVENTION

It is well known in the art of sensing that calibration of a sensor is generally required in order to convert a sensor response to information which is useful to an operator. In some fields, such as gas sensing, it is common for sensor units to be manufactured or sold separately to sensor driver circuits to which they are connected in use. Sensor units may be calibrated when they are commissioned or the sensor manufacturing process can include a calibration step. The resulting sensor units are sold with calibration data which can be manually input into a sensor driver and used to provide a calibrated output from the sensor unit. This is known, for example, with amperometric and optical gas sensors.

It is known for sensors to incorporate calibration circuits which carry out calibration during use. However, for very sensitive sensors which produce small currents the resulting electrical interference affects the sensitivity and accuracy limit of the devices.

US patent application publication number US 2010/0122905 discloses an amperometric in-pipe electrochemical sensing probe. This known sensing probe includes a removable sensing head and a processing circuit. A sensing circuit within the probe includes stored calibration data.

Some aspects of the present invention aim to provide modified sensor units which address the above problems and which are also usable with known sensor drivers.

### SUMMARY OF THE INVENTION

In a first aspect the present specification discloses a sensing system comprising:
a sensor unit and a sensor driver to which the sensor unit is demountably attachable;
the sensor unit comprising a sensing circuit having an output, and a sensor memory circuit comprising a memory for storing data specific to said sensing circuit;
the sensor memory circuit and the sensing circuit being electrically isolated from one another within the sensor unit;
the stored data comprising at least calibration data;
the sensor driver configured to read at least the calibration data from the memory of a mounted sensor unit and to receive the output from the sensing circuit of the attached sensor and process said output taking into account said calibration data.

Calibration data may be written to the memory during manufacture and testing and used by the sensor driver during operation to calibrate measurements. However, because the sensing circuit and the sensor memory circuit are electrically isolated within the sensing unit, meaning electrically isolated from one another within the sensor unit, the calibration procedure need not affect the sensing circuit, allowing the sensing circuit to be very sensitive. Thus, there is no conductive electrical circuit path extending between the sensing circuit and the sensor memory circuit within the sensor unit. This contrasts with devices in which calibration takes place within the sensor unit, or where calibration data is integral to the sensing circuit, which inherently generates some electrical interference due to the passage of electrical current in the sensor unit and the presence of additional electronic conductors and components not directly required for sensing.

That the sensor unit comprises a sensing circuit having an output, and a sensor memory circuit comprising a memory for storing data specific to said sensor unit enables the sensor unit to be calibrated independently of the sensor driver. Calibration data may then be written to the memory where they are stored. A calibration may be a re-calibration. Amperometric gas sensors generally require re-calibration from time to time to compensate for changes in the sensor chemistry for example, or to compensate for environmental conditions such as temperature and humidity. In this way, calibration or recalibration of a sensor unit does not require the sensor unit to be attached to the sensor driver. Calibration (or recalibration) of a sensor may however also be effected with the sensor unit connected to a calibration driver.

Furthermore, the sensor unit may be operated without calibration taking place within the sensing circuit and without affecting the operation of the sensing circuit during use.

Data specific to said sensing circuit may mean data specific to the sensing unit.

Typically, the memory for storing data specific to said sensing circuit is non-volatile, that is to say that the information stored in the memory is retained when power to the memory is removed or switched off. The memory may comprise or be a memory integrated circuit. The sensor memory circuit may comprise a processor, typically a processor integrated circuit, (for example a microprocessor or microcontroller) which comprises both the memory and a processor circuit in electronic communication with the memory (but still electrically isolated from the sensing circuit within the sensor unit).

A sensing system according to claim 1, whereby the sensor driver comprises a plurality of first ports, configured to engage with corresponding first conductors (typically pins) of the sensor unit, whereby the sensor driver and the sensor unit are thereby demountably engageable to each other. The first conductors of the sensor unit may typically be pins.

The engagement of a first port with the corresponding pin of the sensor unit typically results in an electrical connection between that first port and the corresponding pin. An electrical connection between a first port and the corresponding pin means that there is an electrical connection between the sensor driver and the sensor unit. It may be that a measurement current is conducted through the electrical connection between a first port and a corresponding pin during use.

The sensor driver may comprise a plurality of second ports, configured to engage with corresponding second conductors (typically pins) of the sensor memory circuit, whereby the sensor driver and the sensor memory circuit are thereby demountably engageable to each other, typically while the plurality of first ports are connected to the corresponding first conductors. The second conductors of the sensor memory circuit may typically be pins.

When a second port is engaged with a corresponding pin of the sensor memory circuit, an electrical connection is typically established between the second port and the corresponding pin. The establishment of an electrical connection between the second port and the corresponding pin, results in the establishment of an electrical connection between the sensor memory circuit and the sensor driver.

The engagement of a second port with the corresponding pin of the sensor unit typically results in an electrical connection between that second port and the corresponding pin.

Thus the sensing circuit and the sensor memory circuit can be separately connected to the sensor driver, facilitating their isolation from each other.

The sensor driver may include processing electronics. The processing electronics may comprise an analogue circuit. The processing electronics may for example comprise a potentiostat. The processing electronics may comprise an analogue to digital converter, for example to convert a current received from a first pin to a digital number. The processing electronics may comprise one or more processors, such as one or more microcontrollers or microprocessors.

The processing electronics may be configured to cause the sensor driver to read at least the calibration data from the memory of a mounted sensor unit and to (typically subsequently) receive the output from the sensing circuit of the attached sensor and process said output taking into account said calibration data.

The processing electronics may comprise a driver memory circuit.

A said second port may be switchably connected to said processing electronics.

A said second port being switchably connected to said processing electronics means that there is a switch situated between a second port and the processing electronics, so that an electrical connection between the second port and the processing circuit can be switchably made and broken. Such a switch may be provided by the provision of a field effect transistor or FET. An FET may be provided in association with any one of said second ports, with each of a selection of said second ports, or with each of all of the second ports.

The sensing circuit may be formed on a first circuit board (e.g. a PCB) and the sensor memory circuit may be formed on a separate second circuit board (e.g. a separate second PCB).

The sensor memory circuit may be detachable from the sensing circuit. What is meant by this is that the sensor memory circuit may be mechanically detachable from the sensing circuit.

The sensing circuit is typically housed within a main housing. The main housing may be considered to be an element of the sensing circuit. That is to say, the sensing circuit may be considered to additionally comprise the main housing. The sensor memory circuit may be detachable from the main housing of the sensing circuit. The main housing may be constructed at least in part from plastic, possibly extruded plastic. The main housing may comprise a recess within which the sensor memory circuit may be received and where it may sit. The sensor memory circuit may sit with a snug fit in the recess. The main housing may comprise holes within the recess configured to receive mounting pins of the sensor memory circuit. The mounting pins of the sensor memory circuit may be barbed, in order to enhance the attachment of the sensor memory circuit to the main housing. A mounting pin may extend from a side of the sensor memory circuit which is adjacent to, or intended to be adjacent to, the main housing of the sensing circuit to a second side of the sensor memory circuit where it becomes a pin for insertion into a port of the sensor driver.

The sensing circuit may be configured to generate a measurement current.

The measurement current may be an electrical current typically representative of a quantity being monitored by the sensor unit. For example, if the sensor unit is an amperometric gas sensor, the measurement current may be representative of the concentration of a particular gas, such as CO₂. The measurement current typically passes through the output of the sensor unit. As the memory is electrically isolated from the sensing circuit it should not cause interference during operation. The sensor driver is configured to interpret a measurement current in terms of a gas concentration (for example). To do so requires calibration data. This calibration data may be supplied to the sensor driver from data stored in the sensor memory circuit.

A measurement current typically passes from the sensor unit to the sensor driver, through the output via electrical connection between the pins of the sensor unit and the plurality of first ports of the sensor driver. Such electrical connection is typically established when the pins of the sensor unit are engaged with the first ports of the driver unit.

It may be that the sensor unit comprises a plurality of electrodes each of which are connected to a separate pin of the sensor unit.

A typical measurement current from an amperometric sensor may be in the nano Ampere range, for example in a ranging extending up to no more than 1,000 nA, no more than 100 nA or no more than 10 nA. As such small currents are subject to noise, the pins of the sensor unit and the corresponding ports of the driver unit must be designed with low noise in mind. The isolation of the sensor memory circuit from the sensor unit is advantageous in keeping noise sources minimal. A separate calibration of the sensing circuit is also advantageous in this respect.

The sensor driver may comprise a power switching circuit configured to switch the power supply to the sensor memory circuit on and off.

It is preferable that the memory of the sensor memory circuit is a non-volatile memory. That is to say, data stored in the memory are not affected by the removal of power to the memory.

During sensing the sensor memory circuit may be powered off, or electrically isolated from the sensor driver.

In powering off the sensor memory circuit, or by otherwise electrically isolating it from the sensor driver, it is ensured that there is no passage of current to or from the sensor memory circuit. This is advantageous as no electrical currents can be picked up in nearby circuits, resulting in noise. Thus a possible source of noise which could perturb a low current signal from the sensing circuit is removed.

The sensor driver may write data to the sensor memory circuit.

In this way a history of the operation of the sensor unit may be recorded. This can be useful for tracking sensor use, for example, and determining when a sensor recalibration should be carried out.

The calibration data may comprise program code representative of an algorithm, or part of an algorithm.

It may be that calibration data in the form of comprise program code representative of an algorithm, or part of an algorithm, may be encrypted. In this way, restrictive access may be provided to the calibration data. For example, the calibration data for a particular sensing circuit may only be accessed if the sensing circuit is used with a particular or a selected sensor driver.

The sensor driver may comprise a driver memory circuit.

As part of the sensor driver, the driver memory circuit may receive data, for example calibration data, from the sensor memory circuit of the sensor unit. Once the driver memory circuit of the sensor driver has received calibration data from the sensor memory circuit of the sensor unit, the sensor memory circuit of the sensor unit no longer requires accessing while the sensor unit is operational, for example, detecting a gas or a gas concentration. In this way a potential source of noise which may disturb low current detection signals can be eliminated.

If the calibration data is in the form of program code representative of an algorithm or part of an algorithm, the algorithm may executed by the sensor driver. This is an improvement over the algorithm (or part algorithm) being executed on the device itself, where noise could be generated, which could be disruptive for a signal, such as a low current sensing signal. The sensor may therefore be manufactured including an algorithm, or part of an algorithm, useful for calculating a measured output.

The sensing circuit may be part of an amperometric gas sensor. The sensor unit may be an amperometric gas sensor. Amperometric gas sensors require recalibration from time to time. A sensor may be recalibrated to establish updated calibration data. The updated calibration data may be written to the memory of the sensing system.

The sensing circuit may comprise a metal oxide sensor.

The stored data may comprise additional useful information, such as user sensor parameters, a look up table or tables for correction factors, information relating to extremes of sensor operation, usage and error counters, manufacturing data, serial number data.

The sensing circuit may be part of an optical sensor. The sensor unit may be an optical sensor.

The sensing circuit may be part of a particle sensor. The sensor unit may be a particle sensor.

In a preferred embodiment, the sensor driver may comprise a temperature sensor. The sensor driver may comprise a humidity sensor. The sensor driver may comprise a combination of a temperature sensor and a humidity sensor.

The response of a senor to a target gas for example is often dependent on environmental conditions, such as temperature and humidity. A temperature sensor enables measurement corrections to be implemented which compensate for the temperature dependence of the sensor response. The temperature compensation data required to calculate a temperature correction may be unique to a particular sensor and may be stored in the memory of the sensor memory circuit. If appropriate humidity compensation data may similarly be stored in the memory of the sensor memory circuit.

The sensor driver may be configured to selectively operate the sensing circuit, or to turn off the sensing circuit.

An amperometric gas sensor operates to detect a target gas when appropriate voltages are applied to the sensor electrodes. This may result in changes to the sensor characteristics. These changes may become significant over time. It can be advantageous to apply operating voltages to the sensor only when required in order to preserve the sensor and/or maintain the sensor characteristics.

The present specification also discloses a sensor unit comprising a sensing circuit having an output, and a sensor memory circuit comprising a memory for storing data specific to said sensing circuit; the sensor memory circuit and the sensing circuit being electrically isolated from one another within the sensor unit; the stored data comprising at least calibration data.

The present disclosure extends to a method of operating a sensing system as herein disclosed, the method comprising the following method steps: attaching the sensor unit to the sensor driver; utilising the sensor driver to bring the sensing circuit into an operational state; reading calibration data from the memory into the sensor driver; obtaining a measurement signal from the output of the sensing circuit responsive to a target gas; utilising the sensor driver to obtain a target gas concentration from said measurement signal and said calibration data.

Putting the sensing circuit into an operational state may mean, if the sensing circuit is part of an amperometric gas sensor for example, applying operational voltages to the electrodes of the gas sensor. Obtaining a measurement signal from the output of the sensing circuit may mean obtaining a current response from the sensing circuit. Calibration data may be read from the memory of the sensor memory circuit prior to operating the sensor, i.e. prior to obtaining a measurement signal from the output of the sensing circuit responsive to a target gas, or even prior to bringing the sensing circuit into an operational state. Calibration data may be read from the memory of the sensor memory circuit and then stored in the driver memory circuit of the sensor driver. This process of reading calibration data from the memory of the sensor memory circuit and storing in the driver memory circuit of the sensor driver may involve running a program code representative of an algorithm or part of an algorithm in the sensor driver. Calibration data may be read from the memory of the sensor memory circuit following a step of operating the sensor, i.e. following a step of obtaining a measurement signal from the output of the sensing circuit responsive to a target gas.

The present disclosure extends to a method of producing a sensor unit comprising a sensing circuit having an output, and a sensor memory circuit comprising a memory for storing data specific to said sensing circuit; the sensor memory circuit and the sensing circuit being electrically isolated from one another within the sensor unit; whereby the method comprises providing the sensor unit; operating the sensing circuit in an atmosphere containing a known amount of a target gas; obtaining a measurement signal from the output of the sensing circuit responsive to the target gas; obtaining calibration data for the sensing circuit which calibration data relate the measurement signal to the known amount of target gas; writing said calibration data to the sensor memory circuit.

### DESCRIPTION OF THE DRAWINGS

An example embodiment of the present invention will now be illustrated with reference to the following Figures in which:

FIG. 1 is a schematic illustration of a sensing system, in which the sensor unit is attached to the sensor driver.

FIG. 2 schematically shows the electrical connections between the sensor and the sensor driver, and the electrical connections between the sensor memory circuit and the sensor driver.

FIG. 3 shows an example of the construction of the sensor unit (FIG. 3(c)) comprising a sensing circuit (FIG. 3(a)) and a sensor memory circuit (FIG. 3(b)).

FIG. 4 shows an example of the sensor driver board.

FIG. 5 is a schematic diagram of the sensor driver.

FIG. 6 is an example of a potentiostat circuit for an amperometric gas sensor.

FIG. 7 is a method of operating a sensing system.

### DETAILED DESCRIPTION

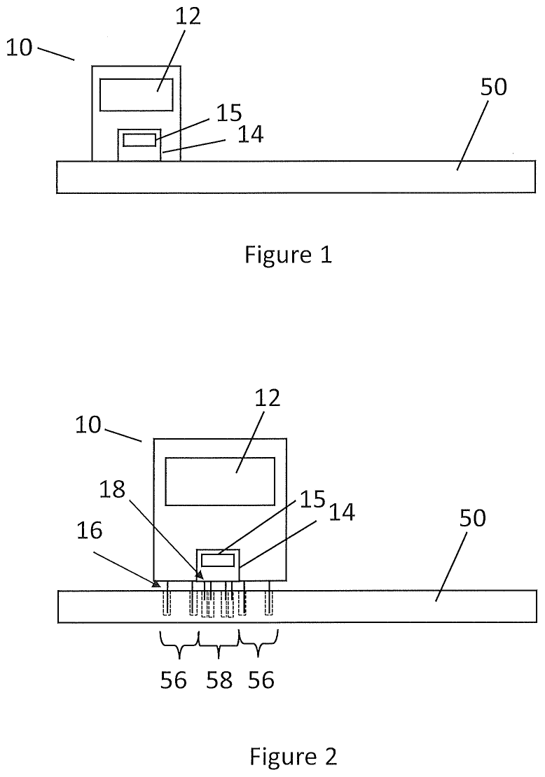

A schematic illustration of the sensing system is shown in FIG. 1. Sensor unit 10, which comprises sensing circuit 12 and sensor memory circuit 14, is engaged with sensor driver 50. Sensor driver 50 is configured to process output from sensor unit 10.

In this illustrated example, sensing circuit 12 is part of an amperometric gas sensor. This is an electrochemical sensing device producing a current output dependent on the amount or concentration of a gas, for example CO₂, NO₂ or H₂S. The output of the sensor is typically in the pA or nA range.

Sensor memory circuit 14 comprises a memory 15. Stored in memory 15 is data specific to sensing circuit 12. Between sensor memory circuit 14 and sensing circuit 12 there is no electrical connection within the sensor unit. In other words, the sensor memory circuit and the sensing circuit are electrically isolated from one another within the sensor unit. Any electrical connection that may be established between sensor memory circuit 14 and sensing circuit 12 must be through the electrical connections serving each of the sensor memory circuit 14 and the sensing circuit 12. Notwithstanding the absence of an electrical connection within the sensor unit between sensor memory circuit 14 and sensing circuit 12, they are mechanically connected to form a single sensing unit. In a preferred embodiment, sensing circuit 12 is provided in a housing and sensor memory circuit 14 is retained within a recess in this housing. The sensor memory circuit may be retained in the recess by any one of several possibilities which will be apparent to the person skilled in the art: the sensor memory circuit may be retained in the recess by an interference fit or snap fit; the sensor memory circuit may be retained using some sort of adhesive, such as epoxy; the sensor memory circuit may comprise placement pins which engage with corresponding apertures in the housing; or a combination of any of these may also be used. The memory of the sensor memory circuit comprises information which is specific to a particular sensor unit, such as calibration data for that sensor, usage information for that sensor (e.g. historical data relating to extremes of sensing circuit operation and/or output), historical data. Other sensing circuit specific data which may be saved in the memory include sensor serial number, manufacturing data, correction factors which can be used to compensate for environmental effects such as humidity and/or temperature.

Sensor driver 50 comprises electronics for running and processing the sensor. The electrical connections between the sensor unit 10 and the sensor driver 50 are provided by conductors, typically in the form of pins 16, 18, extending from the sensor unit 10 and corresponding ports 56, 58 present in the sensor driver unit 50. The pin conductors 16 are shown schematically in FIG. 2. Although FIG. 2 shows four pins 16 associated with the sensor/sensing circuit 12, and four pins 18 associated with the sensor memory circuit 14, this is purely illustrative. The number of pins and ports will depend on the details of the sensor unit. Similarly, it will be apparent to the person skilled in the art that the number of ports 56, 58 in the sensor drive 50 will depend on the details of the sensing system.

FIG. 2 shows the sensing circuit physically separated from the sensor memory circuit, illustrating their isolation from each other. As described above however, it can be advantageous to have the sensor memory circuit physically attached to the sensing circuit, for example retained in a recess in the housing of the sensing circuit.

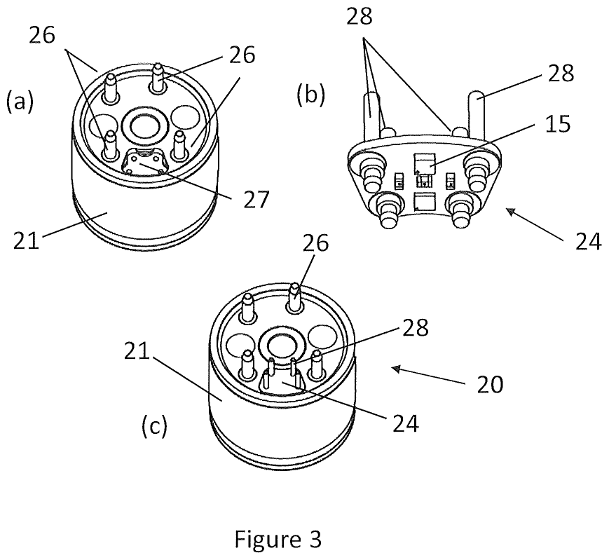

The images of FIGS. 1 and 2 are highly schematic. An example of the sensor unit is shown in FIG. 3. FIG. 3(a) illustrates a housing unit 21 which contains the sensing circuit. Four pin conductors 26 extend from the housing unit. These pin conductors are electrically connected to the sensing circuit, allowing the necessary voltages to be applied to the electrodes of the amperometric sensor, and also the output (measurement) signal of the sensor to be accessed. At a larger scale than FIG. 3(a), FIG. 3(b) shows an example of the sensor memory circuit 24. Elements of the sensor memory circuit 24, including the memory (memory IC 15) for storing data specific to the sensing circuit, are seen on what is presented as the underside of a board. Also on this sensor memory circuit board underside are four pins. A recess 27 is provided in housing 21 for receiving sensor memory circuit 24. Present in this recess are four holes (see FIG. 3(a)) configured to receive the pins on the underside of the sensor memory circuit board. In this way sensor memory circuit 24 may be accommodated in housing 21 as illustrated in FIG. 3(c).

The pins of sensor memory circuit 24 which are utilised in the example of FIG. 3 to physically attach sensor memory circuit 24 to the housing 21 of the sensing circuit may be extensions of pins 28, seen to extend on the other (as illustrated, upper) side of the sensor memory circuit board. Pins 28 provide the electrical connections to the electronic elements of the sensor memory circuit, such as the memory. The sensor unit of FIG. 3(c) presents a total of eight pins. The four pins of larger size provide the electrical connections to the sensing circuit, necessary for operation of the sensing circuit. The four pins of smaller size provide the electrical connections to the sensor memory circuit. In the sensor unit 20 illustrated in FIG. 3(c), there is no electrical connection between the pins of larger size and the pins of smaller size. In other words, the sensor memory circuit is electrically isolated from the sensing circuit within the sensor unit 20.

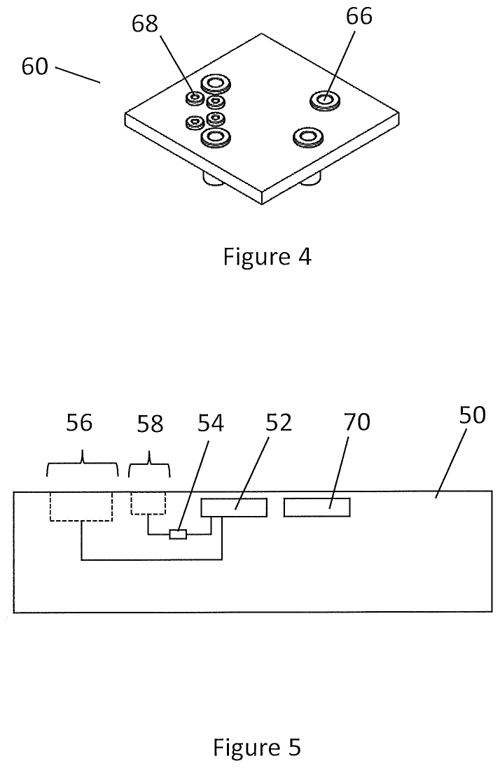

An example of the board of sensor driver 60 is shown in FIG. 4. Four first ports 66 and four second ports 68 are provided in the board of sensor driver 60. The first ports 66 are for engaging pin conductors 26 which connect to the sensing circuit. The second ports 68 are for engaging pin conductors 28 which connect to the sensor memory circuit 24.

A schematic diagram of a sensor driver 50, illustrating elements of the driver, is shown in FIG. 5. The first 56 and second 58 ports to receive pins from the sensing circuit 12 and from the sensor memory circuit 14 respectively are shown schematically. The number of ports in the sensor driver is application dependent, for example the number is dependent on the type of sensor or on the type of measurement. The schematic diagram of FIG. 5 shows some connections between elements of the sensor driver, such as a connection from port group 58 to processing electronics 52 via switch 54, but it does not show all connections. The absence in FIG. 5 of an illustrated connection does not imply a disclosure of no connection.

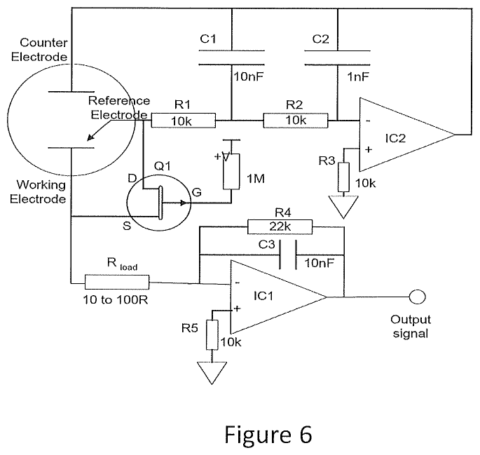

The sensor driver illustrated in FIG. 5 comprises processing electronics 52. The processing electronics are responsible firstly for placing the sensing circuit 12 in a state such that it may perform its sensing task and secondly for reading the output from the sensing circuit and transforming the output signal into information which is useful for the operator, such as a partial concentration of CO₂ (for example). An amperometric sensor typically has two or three electrodes (although versions with four electrodes are also known). To place an amperometric sensor in a state for sensing, a voltage is placed between the counter electrode and the working electrode. The target gas of interest oxidises or reduces on the working electrode thereby causing a current to flow, which current is generally proportional to the concentration of target gas. The processing electronics 52 are responsible for applying the potential difference between counter and working electrode. The processing electronics 52 are then also utilised to collect the output current produced by the reaction of the target gas on the working electrode and convert this into useful information. The function of applying a voltage and detecting an output current is typically performed by a potentiostat circuit. A typical potentiostat circuit suitable for an amperometric gas sensor is illustrated in FIG. 6. Such a potentiostat circuit forms part of the processing electronics 52.

The output of an amperometric sensor is a current signal. Determining the target gas concentration which corresponds to the current signal requires that the sensor be calibrated. In other words, calibration data for any sensor need to be obtained through a calibration process and this calibration data needs to be accessed to interpret the output of the sensor. A calibration process may be performed when a sensor is manufactured, or when a sensor is first put into operation. A calibration process may also be required from time to time as sensor properties drift over time.

Calibration data may take the form of a look up table matching current output values to target concentration values. Calibration data may take the form of parameters, or an algorithm or part of an algorithm, or a combination of parameters and an algorithm (or part thereof). Whatever form the calibration data might take, they can be retained in memory 15 of sensor memory circuit 14.

Calibration data may take the form of program code representative of an algorithm, or part of an algorithm, and it may be encrypted. In this way, restrictive access may be provided to the calibration data. For example, the calibration data for a particular sensing circuit may only be accessed if the sensing circuit is used with a particular or a selected sensor driver.

Look up tables may also be used to correct sensor measurements for the effects that environmental conditions such as temperature or humidity have on the sensor output.

Calibration data relevant to the sensing circuit is stored in the memory of the sensor memory circuit of the sensor unit. This data may be accessed by sensor driver 50. The calibration data may be written to a driver memory 70 which is part of the sensor driver 50.

Sensor driver 50 may also power the memory of the sensor memory circuit of the sensor unit, and may also remove power from the memory. It may be advantageous to remove power from the memory of the sensor memory circuit during operation of the sensor. This may be advantageous to reduce the quantity of electrical currents flowing in the sensor unit, thereby reducing the quantity of sources of noise which may disrupt a low current signal.

Calibration data are generally unique to a particular sensor and also to the history of the sensor. Calibration data may take the form of various parameters (offset, gain, calibration curves, lookup tables etc.).

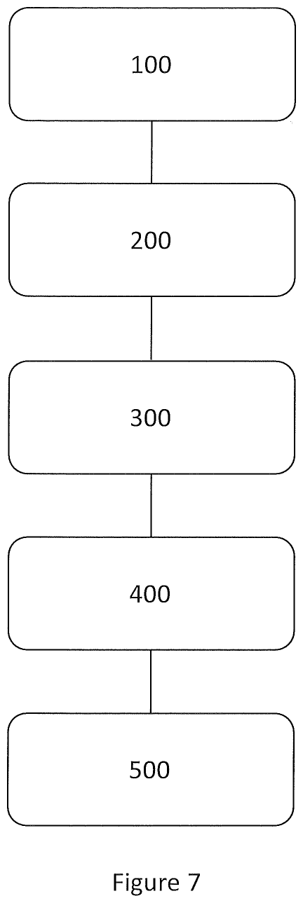

A flow diagram of one embodiment of a method of operating a sensing system according to the present disclosure is illustrated in FIG. 7. In this method of operating the sensing system, the sensor unit is attached to the sensor driver 100; the sensor driver is utilised to bring the sensing circuit into an operational state 200; a measurement signal from the output of the sensing circuit responsive to a target gas is obtained 300; calibration data is read from the memory into the sensor driver 400; and the sensor driver is utilised to obtain a target gas concentration from said signal and said calibration data 500.

In some embodiments the memory 15 comprises additional data concerning the sensor unit, such as a serial number, time of manufacturer, expiry date, warranty data etc. Data may be written to the memory from the sensor driver 50 or updated during use. For example, the memory 15 may store a usage log, such as a counter which is incremented periodically (e.g. every minute) during operation. If more complex functionality is required, for example onboard encryption and decryption of data stored in memory, a microprocessor or microcontroller IC comprising memory may be used in the memory circuit instead of a memory IC.

Usefully, the sensing unit may be operated with legacy sensor drivers which are unable to read the calibration data from the memory. In that case, calibration data is simply manually entered as before. Sensing units can also be manufactured with and without the memory circuit simply by including the memory circuit in some products and not others, enabling efficient manufacture of sensors according to the invention and legacy sensors.

1. A sensing system comprising:
a sensor unit and a sensor driver to which the sensor unit is demountably attachable;
the sensor unit comprising a sensing circuit having an output, and a sensor memory circuit comprising a memory for storing data specific to said sensing circuit;
the sensor memory circuit and the sensing circuit being electrically isolated from one another within the sensor unit;
the stored data comprising at least calibration data;
the sensor driver configured to read at least the calibration data from the memory of a mounted sensor unit and to receive the output from the sensing circuit of the attached sensor and process said output taking into account said calibration data.

2. A sensing system according to claim 1, whereby the sensor driver comprises a plurality of first ports, configured to engage with corresponding first conductors (typically pins) of the sensor unit, whereby the sensor driver and the sensor unit are thereby demountably engageable to each other.

3. A sensing system according to claim 1, whereby the sensor driver comprises a plurality of second ports, configured to engage with corresponding second conductors (typically pins) of the sensor memory circuit, whereby the sensor driver and the sensor memory circuit are thereby demountably engageable to each other, typically while the plurality of first ports are connected to the corresponding first conductors.

4. A sensing system according to claim 1, wherein the sensor driver includes processing electronics.

5. A sensing system according to claim 4, wherein a said second port is switchably connected to said processing electronics.

6. A sensing system according to claim 1, whereby the sensing circuit is formed on a first circuit board and the sensor memory circuit is formed on a separate second circuit board.

7. A sensing system according to claim 1, whereby the sensing circuit is configured to generate a measurement current.

8. A sensing system according to claim 1, wherein the sensor driver comprises a power switching circuit configured to switch the power supply to the sensor memory circuit on and off.

9. A sensing system according to claim 1 configured such that during sensing the sensor memory circuit may be powered off, or electrically isolated from the sensor driver.

10. A sensing system according to claim 1, wherein the sensor driver is configured to write data to the sensor memory circuit.

11. A sensing system according to claim 1, whereby the calibration data comprises an algorithm, or part thereof.

12. A sensing system according to claim 1, whereby the sensor driver comprises a driver memory circuit.

13. A sensing system according to claim 11, whereby the algorithm is executed by the sensor driver.

14. A sensing system according to claim 1, whereby the stored data comprises additional useful information.

15. A sensing system according to claim 1, whereby the sensing circuit is part of an amperometric gas sensor, or a metal oxide sensor.

16. A sensing system according to claim 1, whereby the sensing circuit is part of an optical sensor.

17. A sensing system according to claim 1, whereby the sensor driver comprises a temperature sensor.

18. A sensing system according to claim 1, whereby the sensor driver is configured to selectively operate the sensing circuit, or to turn off the sensing circuit.

19. A sensor unit comprising a sensing circuit having an output, and a sensor memory circuit comprising a memory for storing data specific to said sensing circuit;
the sensor memory circuit and the sensing circuit being electrically isolated from one another within the sensor unit;
the stored data comprising at least calibration data.

20. A method of operating a sensing system according to claim 1 comprising the following method steps:
attaching the sensor unit to the sensor driver;
utilising the sensor driver to bring the sensing circuit into an operational state;
reading calibration data from the memory into the sensor driver;
obtaining a measurement signal from the output of the sensing circuit responsive to a target gas;
utilising the sensor driver to obtain a target gas concentration from said measurement signal and said calibration data.
